(19) United States
(12) Patent Application Publication
(10) Pub. No.: US 2020/0247039 A1
(43) Pub. Date: Aug. 6, 2020

(54) THREE-DIMENSIONAL FORMING METHOD

(71) Applicants: XYZPRINTING, INC., NEW TAIPEI CITY (TW); KINPO ELECTRONICS, INC., NEW TAIPEI CITY (TW)

(72) Inventors: Wei-Chun JAU, NEW TAIPEI CITY (TW); Tsung-Hua KUO, NEW TAIPEI CITY (TW)

(21) Appl. No.: 16/453,225

(22) Filed: Jun. 26, 2019

(30) Foreign Application Priority Data
Jan. 31, 2019 (CN) 201910099999.2

(51) Int. Cl. B29C 64/129; B29C 64/255; B29C 64/245; B29C 64/264; B29C 64/357

(52) U.S. Cl. CPC B29C 64/129; B29C 64/255; B33Y 10/00; B29C 64/264; B29C 64/357; B29C 64/245

(57) ABSTRACT

A three-dimensional forming method having following steps is provided. A forming tank containing a forming liquid and a forming platform arranged thereover is provided, the forming tank has an annular wall and an oxygen permeable membrane covering a bottom thereof, an internal bottom surface closing the bottom is defined on one surface of the oxygen permeable membrane, and an exposed surface is defined exposing on the other surface thereof. Oxygen is spread on the internal bottom surface via the exposed surface. A curing illumination is projected for curing, and the forming liquid contacted with the internal bottom surface is reacted with oxygen to inhibit curing. The curing illumination is shut after the forming liquid is cured. Previous step is repeated. Waiting for a spreading period since the illumination is shut and until the oxygen is spread on internal bottom surface. The forming platform is mono-directionally moved in each repeat.

### BACKGROUND OF THE INVENTION

### 1.Technical Field

The present disclosure is related to a three-dimensional forming method, and in particular to a rapid forming three-dimensional forming method is provided in the present disclosure.

### 2. Description of Related Art

A forming method of a stereolithography printer (SLA 3D printer) is to project a UV light to a predetermined area of a forming liquid (UV resin) contained in a tank. Thereby a layer piece is solidified in the area of the forming liquid. Another layer piece could be stacked on the solidified layer piece by repeat the aforementioned step, and the model could be formed by the stack of layer piece. A conventional stereolithography printer could be bottom up type or top down type according to a projecting direction of UV light projected by the stereolithography printer.

The present disclosure is related to a bottom up type printer, the tank of the bottom up type printer should be light transmissive, a forming liquid contained in the tank could be projected by a UV light projected from a UV source arranged under the tank. The bottom up type printer includes a forming platform arranged over the tank, the forming platform is descended into the forming liquid and a slim gap is thereby maintained between the forming platform and a bottom of the tank. The UV light is projected to a predetermined area on the forming platform, and the forming liquid in the area and between the forming platform and the bottom of the tank is thereby solidified to form a layer piece. Then, the forming platform is lifted, and a slim gap is thereby formed between the aforementioned layer piece and the bottom of the tank for solidifying another layer piece. The layer piece is easy to be stuck on the bottom of the tank, and the forming platform therefore cannot be rapidly lifted. Therefore, a special cover is coated in on the bottom of the tank to make it easier to remove the layer piece from the bottom. A bottom of a conventional top down type tank is usually covered by a Teflon film.

The Teflon film has good resistance of tensile strength, and a glass plate is generally used as the bottom of the tank under the Teflon film to support and tight the Teflon film. Teflon is pulled up when a layer piece is solidified and the platform is lifted, because the layer piece is bonded with the Teflon film. Therefore, the forming platform should be moved up and down to remove the object from the Teflon film. Accordingly, printing time is increased and the printer cannot print rapidly.

Silicone materials are soft, and an acrylic plate is generally used as the bottom of the tank. A liquid silicone is poured onto the acrylic plate and cured to form a silicone film. Oxygen can infiltrate silicone and can be absorb by silicone, oxygen is released into the sink and an oxygen inhibition layer is formed on the surface of the silicone film during a printing process. The oxygen inhibition layer decreases stickiness between the layer piece and the silicone film and they are therefore easy to be separated. A series of related studies were conducted by Dr. Doyle group of the Massachusetts Institute of Technology (MIT), and the first report about speeding up curing process of photocurable resins by oxygen Inhibition layer was published on Nature Materials Letters in April 2006. A simulation by calculation method about determining a distribution of oxygen diffused into a device from the atmosphere via Polydimethylsiloxane (PDMS) was then published on Macromolecules in October 2008.

“Synthesis of biomimetic oxygen-carrying compartmentalized microparticles using flow lithography” written by Dr. Doyle group was published on Lab on a Chip 13.24 (2013): 4765-4774. This paper recited that oxygen could be dissolved in Fluorocarbons (PFC) added in the photocurable resins. It has been found according to experiment that the higher the oxygen content is, thicker the thickness of the oxygen inhibition layer is. Fluoride leads to a worse accuracy of curing process, and the curing time therefore becomes long. According to this research, inert gas added in the tank leads to better accuracy of curing process. The inert gas also decreases the content of oxygen in the fluorocarbon, and leads to better accuracy of curing process. The lower the concentration of oxygen in the tank is, the less the thickness of the oxygen inhibition layer is. The effects of oxygen concentration on the thickness of the oxygen inhibition layer and solidification were discussed in this paper. However, atmosphere was applied rather than high concentration oxygen, so the maximum oxygen concentration is 21%.

An article written by Dr. Doyle group about controlling print quality by oxygen concentration was published on Soft Material in July 2014. In October 2014, “Stop Flow Lithography in Perfluoropolyether (PFPE) Microfluidic Channels” was published on Lab on a Chip 14.24 (2014): 4680-4687. This article described that the Perfluoropolyether (PFPE) is substituted by Polydimethylsiloxane (PDMS). Polydimethylsiloxane is easy to react with organic solvents, but perfluoropolyether is soft and has a lower oxygen permeability.

A technical solution for avoiding cured layer piece from sticking on PDMS by the oxygen inhibition layer piece was proposed in US 2013/0295212 A1. Oxygen is consumed during chemical reaction with the photocurable resin. Therefore, silicone should be exposed in atmosphere after curing process of each layer piece, and oxygen could be absorbed by the silicone. For example, according to US 2013/0295212 A1, the photocurable resin on at least a part of the silicone is temporarily scraped out between sequential curing procedures for exposing the silicone in atmosphere to absorb oxygen. This solution leads to increase of printing time.

In order to print rapidly, oxygen should infiltrate into the tank through the bottom of the tank. However, oxygen can infiltrate through neither glass nor Acrylic, oxygen therefore cannot infiltrate into the tank through the bottom of the tank. The patent CN105122135A and WO2014126837A3 of Carbon 3D recite that a dead zone with specific thickness could be formed on the silicone film by supplying pressured oxygen to where under the silicone film. The forming liquid in the dead zone cannot be cured, the layer pieces are thereby separated from the silicone film, and the printer can print rapidly. However, the film is bent by expansion of pressured air and weight change of the forming liquid in the tank, the film might be bent when a balance between the pressure and the weight is changed. Each layer piece formed on an uneven file is also uneven, and a model formed by a stack of the layer pieces will be incorrect.

In views of this, in order to solve the above disadvantage, the present inventor studied related technology and provided a reasonable and effective solution in the present disclosure.

### SUMMARY OF THE INVENTION

A rapid forming three-dimensional forming method is provided in the present disclosure.

A three-dimensional forming method shown in an embodiment of the present disclosure has following steps. A forming tank containing a forming liquid and a forming platform arranged over the forming tank is provided, the forming tank has an annular wall and an oxygen permeable membrane, a bottom of the annular wall is covered by the oxygen permeable membrane, an internal bottom surface is defined on one surface of the oxygen permeable membrane for closing the bottom of the annular wall, and an exposed surface is defined exposing on the other surface of the oxygen permeable membrane. Oxygen is spread on the internal bottom surface through the oxygen permeable membrane via the exposed surface, a curing illumination is projected through the oxygen permeable membrane to cure the forming liquid, a portion of the illuminated forming liquid contacted with the internal bottom surface is meanwhile reacted with oxygen and a curing action thereof is thereby inhibited, the curing illumination is shut after a predetermined period, and the present step is repeated and a time difference is defined since the present step is completed and until the present step is executed again. Waiting for a spreading period and until oxygen contained in the oxygen permeable membrane is spread on internal bottom surface to replenish the consumed oxygen during a reaction, and the present step is executed immediately after each time that the previous step is completed. The forming platform is mono-directionally moved to elevate the forming platform a layer thickness and then stop moving the forming platform, and the present step is executed in each time difference.

According to the embodiment of the present disclosure, the forming tank is raised by a base and the exposed surface is thereby exposed. Oxygen is supplied to flow through the base to contact the exposed surface.

According to the embodiment of the present disclosure, oxygen is supplied to flowing through the exposed surface.

According to the embodiment of the present disclosure, an elevating period during the forming platform elevating the layer thickness is equal to or larger than the spreading period, and the time difference is equal to the elevating period.

According to the embodiment of the present disclosure, an elevating period during the forming platform elevating the layer thickness is less than the spreading period, and the time difference is equal to or larger than the spreading period.

According to the embodiment of the present disclosure, a plurality of portions on the oxygen permeable membrane is pressed along a direction perpendicular to the oxygen permeable membrane to flatten the oxygen permeable membrane. The oxygen permeable membrane is upward pressed along a direction perpendicular to the oxygen permeable membrane, or the oxygen permeable membrane is downward pressed along a direction perpendicular to the oxygen permeable membrane.

According to the embodiment of the present disclosure, a holder is provided, and a peripheral edge of the oxygen permeable membrane is clamped between a lower edge of the annular wall and the holder.

The embodiment of the present disclosure further has determining whether an area of the subsequently printed layer piece is larger than an applicable maximum, and reciprocating the forming platform if the subsequently printed layer piece is larger than an applicable maximum. The reciprocating the forming platform elevates the forming platform over the layer thickness in first and then descends the forming platform to the layer thickness. The oxygen is supplied through the internal bottom surface during the spreading period to replenish the consumed oxygen during a reaction.

According to the embodiment of the present disclosure, oxygen is allowed to pass the oxygen permeable membrane for inhibiting curing of the forming liquid contacted with the oxygen permeable membrane, and the cured forming liquid is thereby prevented from sticking on the oxygen permeable membrane. Accordingly, the forming platform only should be moved mono-directionally, and the time difference between illumination steps could be decreased. The oxygen consumed in reaction could be rapidly replenished via the exposed surface of the oxygen permeable membrane by waiting for replenishing of oxygen through the oxygen permeable membrane since each shutting of illumination and until the subsequently illumination.

### BRIEF DESCRIPTION OF DRAWING

The present disclosure can be more fully understood by reading the following detailed description of the embodiment, with reference made to the accompanying draw.

FIG. 1 is a flowchart showing the three-dimensional forming method according to an embodiment of the present disclosure.

FIGS. 2 and 3 are schematic views showing a three-dimensional forming device provided in three-dimensional forming method according to the embodiment of the present disclosure.

FIGS. 4 and 5 are schematic views showing the three-dimensional forming method according to the embodiment of the present disclosure.

FIG. 6 is a schematic view showing another embodiment of pressing the oxygen permeable membrane provided in the three-dimensional forming method according to the embodiment of the present disclosure.

FIG. 7 is a schematic view showing another embodiment of the holder provided in the three-dimensional forming method according to the embodiment of the present disclosure.

FIG. 8 is a schematic view showing another arrangement of the illumination module provided in the three-dimensional forming method according to the embodiment of the present disclosure.

FIG. 9 is a flowchart showing a modification of the three-dimensional forming method according to the embodiment of the present disclosure.

### DETAILED DESCRIPTION OF THE INVENTION

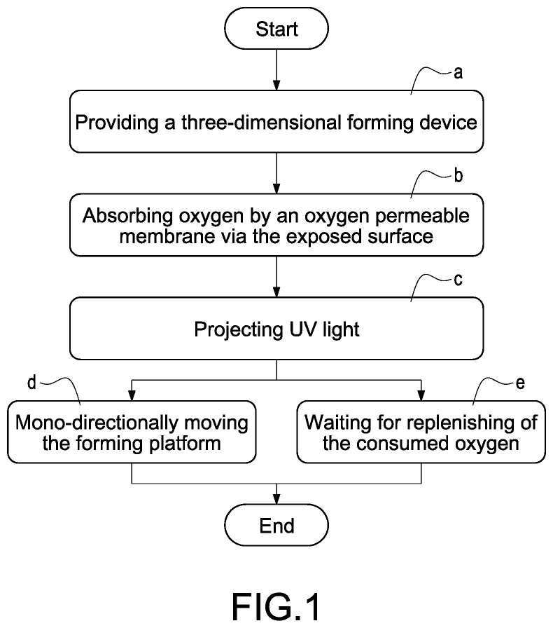

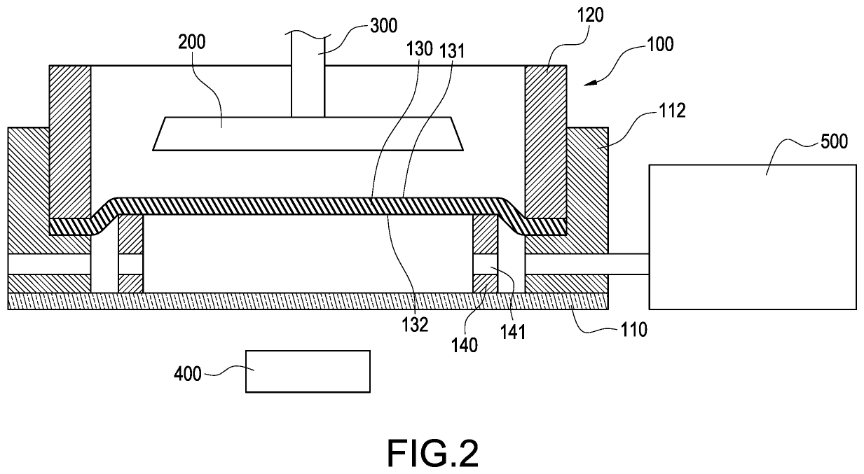

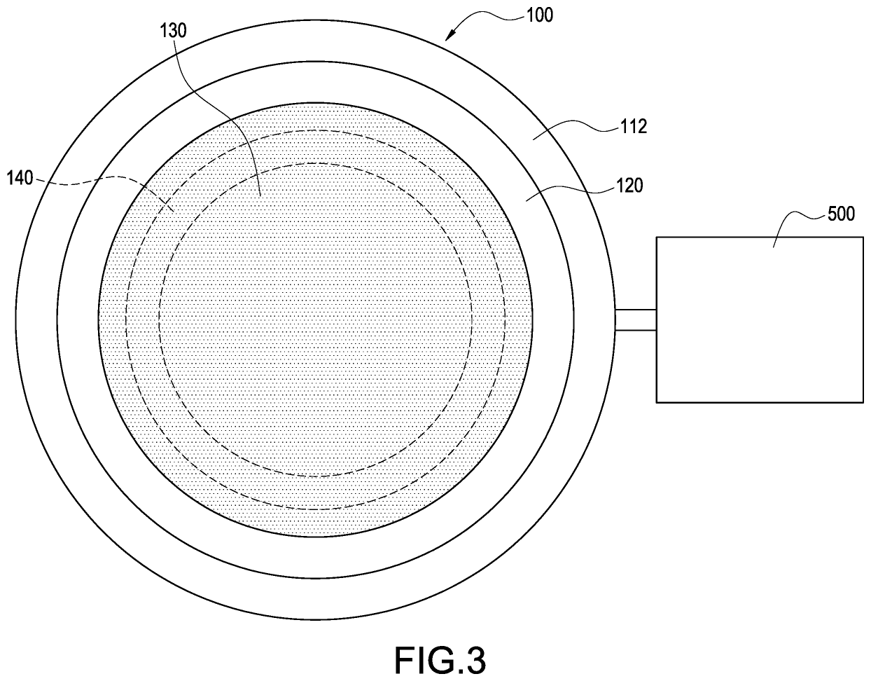

According to the three-dimensional forming method of an embodiment of the present disclosure shown in FIG. 1, the method is implemented via a three-dimensional forming device shown in FIGS. 2 and 3. The three-dimensional forming method of the present disclosure has following steps.

According to step a shown in FIGS. 1 to 4, the three-dimensional forming device is provided, the three-dimensional forming device has at least one forming tank 100 for containing a forming liquid 10 and a forming platform 200 arranged over the forming tank 100. The forming tank 100 has an annular wall 120 and an oxygen permeable membrane 130, a bottom of the annular wall 120 is closed by the oxygen permeable membrane 130. According to the present embodiment, the aforementioned three-dimensional forming device has a forming tank 100, a forming platform 200, an elevating mechanism 300 and an illumination module 400. It is worthy to note that although the forming tank 100 or the annular wall 120 shown in Figs. are circular-shaped, scopes of the present disclosure should not be limited thereby. Other alternative shapes such as rectangular-shaped could also be implemented.

In general, the forming liquid 10 is UV resin, and the forming liquid 10 could be cured by exposing in a curing illumination. Specifically, according to the present embodiment, the forming tank 100 has a base 110, an annular wall 120 and an oxygen permeable membrane 130. An open chamber 111 is defined in the base 110, the annular wall 120 is arranged on the base 110, and the oxygen permeable membrane 130 is horizontally fixed on a lower edge of the annular wall 120. A peripheral edge of the oxygen permeable membrane 130 is fixed on the lower edge of the annular wall 120. An internal bottom surface 131 closing the bottom of the annular wall 120 is defined on one surface of the oxygen permeable membrane 130, and an exposed surface 132 is defined exposing on the other surface of the oxygen permeable membrane 130. The bottom of the annular wall 120 is closed by the internal bottom surface 131 of the oxygen permeable membrane 130, and the exposed surface 132 of the oxygen permeable membrane 130 is exposed in the open chamber 111 for contacting with oxygen. The oxygen permeable membrane 130 could be a silicone film, and it is a Polydimethylsiloxane (PDMS) film according to the present embodiment.

The forming platform 200 is arranged over the forming tank 100 and downward aligned to an area defined within the annular wall 120. The elevating mechanism 300 is connected with the forming platform 200 for elevating the forming platform 200 relative to the oxygen permeable membrane 130.

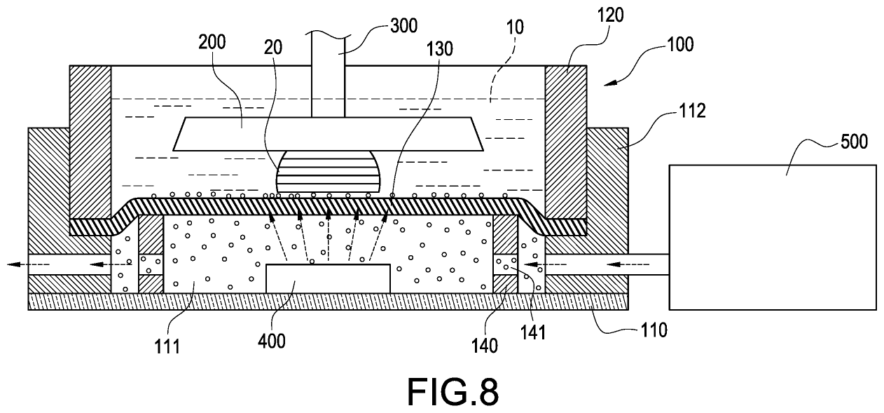

The illumination module 400 is arranged under the oxygen permeable membrane 130 corresponding to a position of the forming platform 200 for projecting a curing illumination to where between the forming platform 200 and the oxygen permeable membrane 130 through the oxygen permeable membrane 130. Specifically, the curing illumination generated by the illumination module 400 is a UV light, but scopes of the present disclosure should not be limited thereby. According to the present embodiment, the illumination module 400 is preferably arranged under the base 110 and the base 110 is light transmissive. Thereby, the illumination module 400 could project light to where between the forming platform 200 and the oxygen permeable membrane 130 through the base 110 and the oxygen permeable membrane 130. According to another arranged of the illumination module 400 shown in FIG. 8, the illumination module 400 could be alternatively arranged in the open chamber 111.

According to step b, oxygen is contacted with the exposed surface 132 of the oxygen permeable membrane 130 and spread to the internal bottom surface 131 through the oxygen permeable membrane 130. The oxygen is supplied by the atmosphere in the open chamber 111.

According to step c shown in FIGS. 1, 4, and 5, the curing illumination is projected to where between the forming platform 200 and the internal bottom surface 131 through the oxygen permeable membrane 130 for curing the forming liquid 10, and a portion of the forming liquid 10 illuminated by the curing illumination and contacted with the internal bottom surface 131 is meanwhile reacted with oxygen and a curing action thereof is thereby inhibited. The curing illumination is shut after illuminating a predetermined period, and the forming liquid 10 illuminated by the curing illumination is cured in the predetermined period. According to the present embodiment, the step c is repeated, and a time difference is defined since the step c is completed and until the step c is executed again. The time difference is a selectable time period.

According to step d, the forming platform 200 is mono-directionally moved to elevate the forming platform 200 to a layer thickness 21 and then stop moving the forming platform 200, and the step d is executed in each time difference.

According to step e, waiting for a spreading period and until oxygen contained in the oxygen permeable membrane 130 is spread on the internal bottom surface 131 to replenish the consumed oxygen during a reaction. The present step e is executed immediately after each time that the step d is completed. Namely, the step d and the step e are executed in the same time period between two steps c (the aforementioned time difference), and the execution of the step d and the step e could spend unequal time.

In a preferable situation, the step d and the step e are simultaneously executed after each step c is completed. When an elevating period during the forming platform 200 elevating the layer thickness 21 is not shorter than the spreading period, the time difference is equal to the spreading period of the spreading period, and the time difference could be controlled equal to the elevating period. In other words, the step c of projecting the curing illumination could be executed immediately when the forming platform 200 is elevated to the layer thickness 21. However, when the elevating period during the forming platform 200 elevating the layer thickness 21 is shorter than the spreading period, the time difference should be controlled equal to or longer than the spreading period.

According to the three-dimensional forming method of the present disclosure, oxygen could be provided to flow through the exposed surface 132 in step b. According to the present embodiment, oxygen is preferably provided to flow through the base 110 and contacted with the exposed surface 132. Specifically, an oxygen supplying module 500 could be selectively provided in the three-dimensional forming method according to the present disclosure. The oxygen supplying module 500 is communicated with the open chamber 111, and the oxygen supplying module 500 could generate oxygen and transfer air containing a specific ratio of oxygen through the open chamber 111.

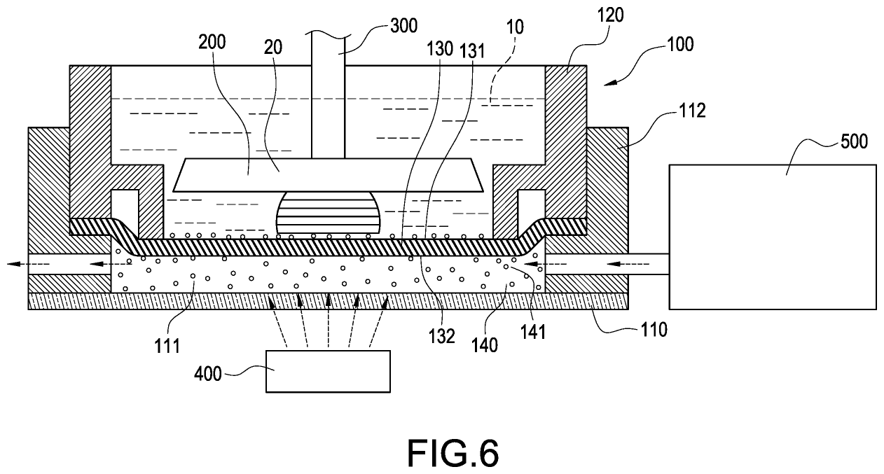

According to the three-dimensional forming method of the present disclosure, in step a, a plurality of portions on the oxygen permeable membrane 130 could be pressed along a direction perpendicular to the oxygen permeable membrane 130 to flatten the oxygen permeable membrane 130. According to the present embodiment, the oxygen permeable membrane 130 is preferably upward pressed along the direction perpendicular to the oxygen permeable membrane 130. Specifically, according to the present embodiment, an expansion frame 140 is arranged on the oxygen permeable membrane 130, the expansion frame 140 is aligned to an area defined within the annular wall 120, and a plurality of portions of the oxygen permeable membrane 130 are pressed by the expansion frame 140 along the direction perpendicular to the oxygen permeable membrane 130, and the oxygen permeable membrane 130 is thereby flattened. The details of the expansion frame 140 are described following, the expansion frame 140 is preferably ring-shaped, but not limited in the present disclosure. For example, the expansion frame 140 could be an annular-shaped ring or a rectangular-shaped ring, and a plurality of through holes 141 are defined on a lateral surface of the expansion frame 140. According to the present embodiment, the expansion frame 140 is preferably arranged under the annular wall 120 and contained in the open chamber 111 of the base 110. A top edge of the expansion frame 140 is upward extended into the annular wall 120, and the exposed surface 132 of the oxygen permeable membrane 130 is thereby upward pressed along the direction perpendicular to the oxygen permeable membrane 130. Oxygen is allowed to contact with the exposed surface 132 of the oxygen permeable membrane 130 through the through holes 141 on the lateral surface of the expansion frame 140. According to another arrangement of the expansion frame 140 shown in FIG. 6, the expansion frame 140 alternatively could be contained in the annular wall 120, the expansion frame 140 is downward extended to exceed a lower edge of the annular wall 120, and the oxygen permeable membrane 130 is thereby downward pressed along the direction perpendicular to the oxygen permeable membrane 130.

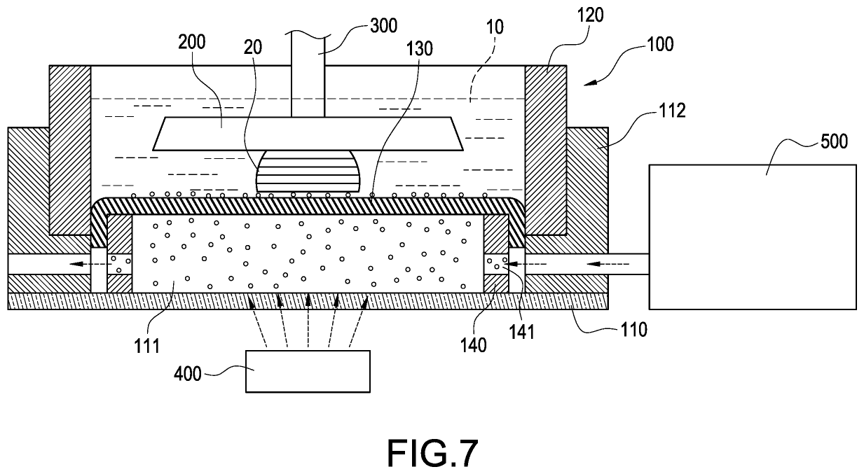

According to the three-dimensional forming method of the present disclosure, a holder could be provided in step a, and the peripheral edge of the oxygen permeable membrane 130 is clamped between the lower edge of the annular wall 120 and the holder. The holder could be a fastening ring 112 in another embodiment, the fastening ring 112 is telescoped with the annular wall 120, the peripheral edge of the oxygen permeable membrane 130 is clamped between the lower edge of the annular wall 120 and the fastening ring 112, and the peripheral edge of the oxygen permeable membrane 130 is thereby fixed on the lower edge of the annular wall 120. According to the present embodiment, specifically, the fastening ring 112 preferably sleeves the annular wall 120, a lower edge of the fastening ring 112 is inward converged to cover the lower edge of the annular wall 120, and the peripheral edge of the oxygen permeable membrane 130 is clamped between the lower edge of the annular wall 120 and the lower edge of the fastening ring 112. According to another embodiment of the holder shown in FIG. 7, the expansion frame 140 could be used as the holder, the expansion frame 140 could be inserted in the lower edge of the annular wall 120, and it is not necessary to fix the oxygen permeable membrane 130 by the fastening ring 112 of the base 110 according to the present arrangement. The peripheral edge of the oxygen permeable membrane 130 could be clamped between the lower edge of the annular wall 120 and the expansion frame 140, and the oxygen permeable membrane 130 is thereby fixed and meanwhile flattened.

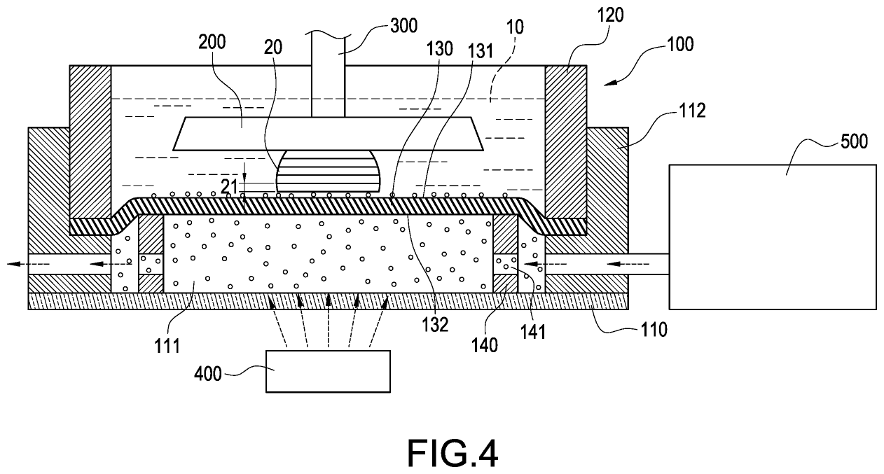

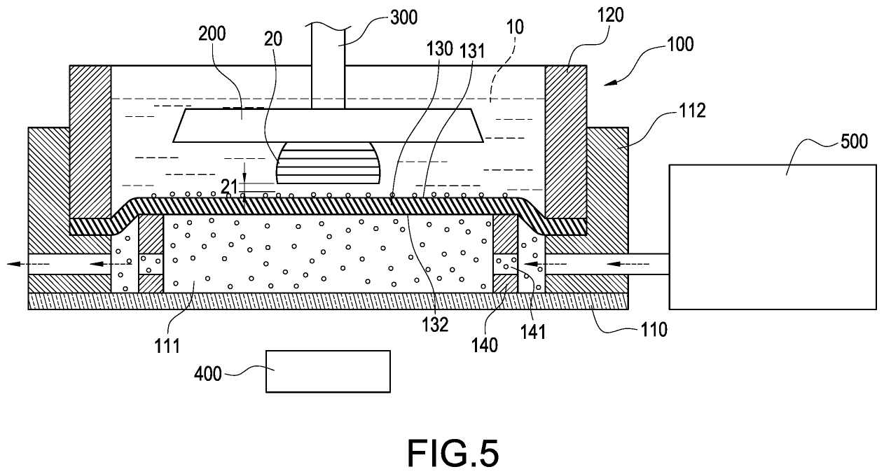

According to FIGS. 4 and 5, oxygen spread on a top surface of the oxygen permeable membrane 130 is reacted with the forming liquid 10 and a curing action of the forming liquid 10 is inhibited. Thereby, a portion of the forming liquid 10 contacted with the oxygen permeable membrane 130 cannot be cured and the layer piece 20 cured in the forming liquid 10 is prevented from sticking on the top surface of the oxygen permeable membrane 130. Therefore, the elevating mechanism 300 could mono-directionally elevate the forming platform 200 to the predetermined position for subsequent curing after the layer piece 20 is cured, and a reciprocating up-down movement or swaying of the layer piece 20 for removing from the oxygen permeable membrane 130 according to conventional technologies are not necessary. When oxygen spread on the top surface of the oxygen permeable membrane 130 is reacted with the forming liquid 10 and consumed, the oxygen contained in the oxygen permeable membrane 130 or in the air in the open chamber 111 naturally spreads to the top surface of the oxygen permeable membrane 130 with lower oxygen concentration, and oxygen is allowed to continuously spread to the internal bottom surface 131 of the oxygen permeable membrane 130 through the open chamber 111 and the exposed surface 132 of the oxygen permeable membrane 130. The oxygen permeable membrane 130 is flattened by the expansion frame 140.

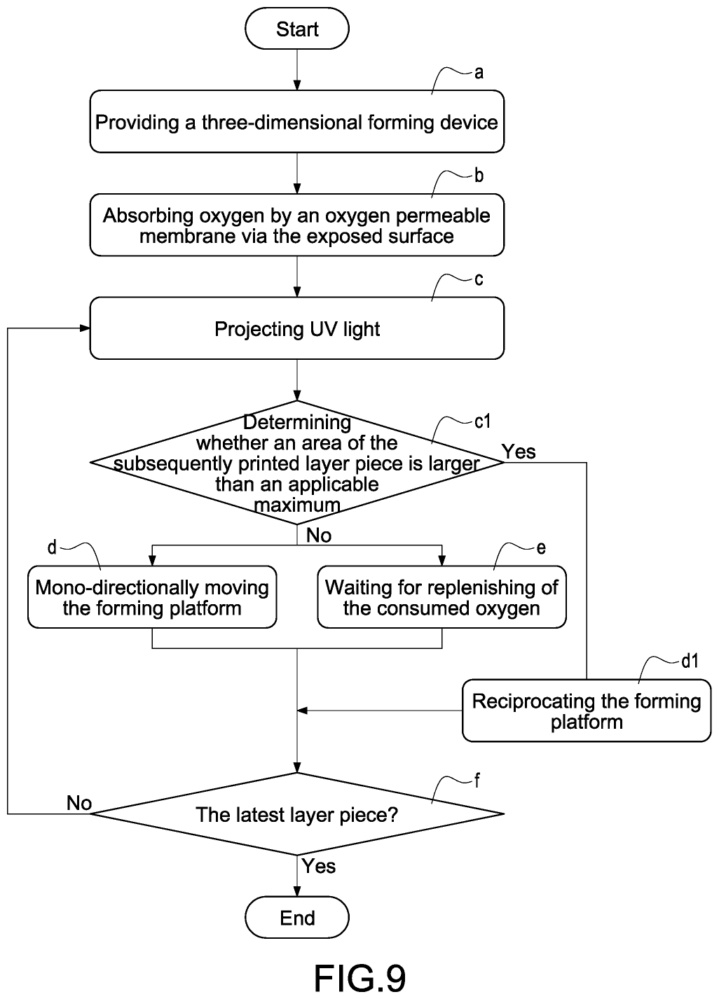

According to the three-dimensional forming method of the present disclosure shown in FIG. 9, a suitable motion for moving the forming platform 200 could be selected according to whether an area of the subsequently printed layer piece is larger than an applicable maximum. Preferably, between step c and step d, a step c1 could be executed for determining whether the subsequently printed area is suitable for the mono-directionally moving of the forming platform 200 in step d. When a larger layer piece is printed, a part of the layer piece still intends to stick on the oxygen permeable membrane 130 and the layer piece is therefore difficult to be removed from the oxygen permeable membrane 130. Accordingly, a larger moving distance of the forming platform 200 is required for ensuring the layer piece can be removed from the oxygen permeable membrane 130. Furthermore, since the oxygen consumption is positively correlated to the area of the layer piece, when a layer piece larger than the applicable maximum is printed, a long period is required for replenish oxygen to the internal bottom surface 131 of the oxygen permeable membrane 130 in step e or for replenish the forming liquid 10 to the remained space under the lifted forming platform 200, and step e is therefore replaced by a step d1. The cured layer piece 20 will be stuck on the oxygen permeable membrane 130 if the step e is uncompleted, and the forming platform 200 is reciprocated by the elevating mechanism 300 according to step d1 rather than mono-directional moved. Specifically, the forming platform 200 is immediately lifted by the elevating mechanism 300 over the predetermined position for subsequent curing after the layer piece 20 is cured and until the previous layer piece 20 is removed from the oxygen permeable membrane 130. Then, the forming platform 200 is further descended to the predetermined position for subsequent curing by the elevating mechanism 300 for executing the next step c.

The aforementioned applicable maximum is determined depending on oxygen concentration and flux of supplied air, thickness and material of the oxygen permeable membrane 130, and compositions of the forming liquid 10. The applicable maximum could be determined by reasonable experiments of printing various areas.

After step d or step d1, a step f could be used for determining if the latest layer piece 20 is accomplished. The subsequent step c will be executed if the latest layer piece 20 is not accomplished, and the printing will be stopped if the latest layer piece 20 is accomplished.

Although the present disclosure has been described with reference to the foregoing preferred embodiment, it will be understood that the disclosure is not limited to the details thereof. Various equivalent variations and modifications can still occur to those skilled in this art in view of the teachings of the present disclosure. Thus, all such variations and equivalent modifications are also embraced within the scope of the present disclosure as defined in the appended claims.

What is claimed is:

1. A three-dimensional forming method for forming a three-dimensional model by forming a plurality of layer pieces, the three-dimensional forming method comprising steps of:
(a) providing a forming tank containing a forming liquid and a forming platform arranged over the forming tank, the forming tank comprising an annular wall and an oxygen permeable membrane, a bottom of the annular wall being covered by the oxygen permeable membrane, an internal bottom surface being defined on one surface of the oxygen permeable membrane for closing the bottom of the annular wall, and an exposed surface being defined exposing on the other surface of the oxygen permeable membrane;
(b) spreading oxygen on the internal bottom surface through the oxygen permeable membrane via the exposed surface;
(c) projecting a curing illumination through the oxygen permeable membrane to cure the forming liquid, and shutting the curing illumination after a predetermined period;
(d) mono-directionally moving the forming platform to elevate the forming platform to a layer thickness and then stopping moving the forming platform; and
(e) waiting for a spreading period since the step (c) is completed;
wherein, the step (c) is repeatedly executed, a time difference is defined since the step (c) is completed and until the step (c) is executed again, the step (d) is executed in each time difference, and the step (e) is executed immediately after each step (c) is completed.

2. The three-dimensional forming method according to claim 1, wherein the forming tank is raised by a base in the step (a) and the exposed surface is thereby exposed.

3. The three-dimensional forming method according to claim 2, further comprising:
supplying oxygen flowing through the base to contact the exposed surface.

4. The three-dimensional forming method according to claim 1, further comprising:
supplying oxygen flowing through the exposed surface.

5. The three-dimensional forming method according to claim 1, wherein an elevating period during the forming platform elevating the layer thickness is equal to or larger than the spreading period, and the time difference is equal to the elevating period.

6. The three-dimensional forming method according to claim 1, wherein an elevating period during the forming platform elevating the layer thickness is less than the spreading period, and the time difference is equal to or larger than the spreading period.

7. The three-dimensional forming method according to claim 1, further comprising:
pressing on a plurality of portions on the oxygen permeable membrane along a direction perpendicular to the oxygen permeable membrane to flatten the oxygen permeable membrane.

8. The three-dimensional forming method according to claim 7, wherein the oxygen permeable membrane is upward pressed along a direction perpendicular to the oxygen permeable membrane.

9. The three-dimensional forming method according to claim 7, wherein the oxygen permeable membrane is downward pressed along a direction perpendicular to the oxygen permeable membrane.

10. The three-dimensional forming method according to claim 1, further comprising:
providing a holder, and a peripheral edge of the oxygen permeable membrane is clamped between a lower edge of the annular wall and the holder.

11. The three-dimensional forming method according to claim 1, further comprising a step (c1) following the step (c): determining whether an area of the subsequently printed layer piece is larger than an applicable maximum, executing step (d) and step (e) and subsequently executing step (c) again if the area of the subsequently printed layer piece is less than the applicable maximum, executing a step (d1) and subsequently executing step (c) again if the area of the subsequently printed layer piece is larger than the applicable maximum, and the step (d1) comprising: reciprocating the forming platform.

12. The three-dimensional forming method according to claim 11, wherein the reciprocating the forming platform in the step (d1) elevates the forming platform over the layer thickness in first and then descends the forming platform to the layer thickness.

13. The three-dimensional forming method according to claim 1, wherein the oxygen is supplied through the internal bottom surface during the spreading period to replenish the consumed oxygen during a reaction.
